(19) United States
(12) Patent Application Publication
(10) Pub. No.: US 2011/0139600 A1
(43) Pub. Date: Jun. 16, 2011

(54) GASEOUS DENSITY CONVECTIVE DESALINATION AND COOLING SYSTEM

(75) Inventors: JIHAD HASSAN AL-SADAH, DHAHRAN (SA); BASIM AHMAD ABUSSAUD, DHAHRAN (SA)

(73) Assignee: KING FAHD UNIVERSITY OF PETROLEUM AND MINERALS, DHAHRAN (SA)

(21) Appl. No.: 12/955,757

(22) Filed: Nov. 29, 2010

(51) Int. Cl. C02F 1/04; B01D 3/00; B01D 3/34; B01D 3/42; F28F 9/00

(52) U.S. Cl. 202/177; 202/232; 202/187; 165/67

(57) ABSTRACT

The fluid density-driven desalination system is an evaporative desalination system utilizing gases having differing molecular weights from that at of water vapor in order to assist in the evaporation and condensation of pure water vapor. Evaporation of pure water from a saline solution through a first capillary evaporator plate is assisted by a first gas having a molecular weight less than that of water vapor, thus driving the evaporated water vapor downwardly for collection and condensation. Similarly, evaporation of pure water from brine through a second capillary evaporator plate is assisted by a second gas having a molecular weight greater than that of water vapor, thus driving the evaporated water vapor upwardly for collection and condensation.

### BACKGROUND OF THE INVENTION

1. Field of the Invention

The present invention relates to desalination systems, and particularly to a fluid density-driven desalination system that provides for evaporative desalination using gases having differing molecular weights with respect to the molecular weight of water vapor in order to assist in the evaporation and condensation of pure water vapor.

2. Description of the Related Art

Due to increasing water shortages around the world, desalination is presently of great interest. Desalination involves the removal of salt from saline or brine, such as that found in ocean water. Common approaches to seawater desalination by distillation include multi-stage flash systems (MSF), multi-effect systems (ME), as well as mechanical (MVC) and thermal (TMC) vapor compression systems. In all of these, a plurality of evaporator tubes are employed for evaporating the seawater and for recovering the evaporation energy.

Evaporative desalination systems are of particular interest in hot and dry arid regions, such as Arabia, for example, because they not only provide potable water from readily available sea water, but also offer the possibility of heat transfer for use in clean energy systems, for evaporative cooling effects, and the like. Multi-stage flash systems and the like require great complexity in their designs, are typically not portable and, in fact, require large-scale plants to be constructed, and do not easily allow for alternative uses, such as evaporative cooling-based refrigeration systems, or for thermal storage. Relatively simple evaporative systems, such as basic solar stills and the like, are highly inefficient and produce low volumes of water.

Thus, a fluid density-driven desalination system solving the aforementioned problems is desired.

### SUMMARY OF THE INVENTION

The fluid density-driven desalination system is an evaporative desalination system utilizing gases having different molecular weights compared to water vapor in order to assist in the evaporation and condensation of pure water vapor. The fluid density-driven desalination system includes a housing having an upper portion and a lower portion, and an upper chamber formed in the upper portion of the housing for storing a volume of saline solution.

The lower portion of the housing is adapted for receiving and containing a volume of brine. The upper portion of the housing external to the upper chamber is adapted for receiving a first gas having a molecular weight less than that of water vapor. The lower portion is similarly adapted for receiving a second gas above the surface of the volume of brine. The second gas has a molecular weight greater than that of water vapor.

A support is mounted in the upper portion of the housing. The support defines a lower wall of the upper chamber. At least one upper evaporator plate is mounted to the support and is in fluid communication with the upper chamber. The evaporator plate extends downward with respect to the support. The upper evaporator plate may be formed from compacted sand or the like, and has a plurality of capillaries defined therethrough so that the saline solution is drawn through the evaporator plate via capillary transport. External faces of the evaporator plate are adapted for accumulation and evaporation of pure water from the saline solution.

Similarly, at least one lower evaporator plate is supported within the lower portion of the housing. The lower end of the lower evaporator plate is in fluid communication with the volume of brine. The lower evaporator plate also has a plurality of capillaries defined therethrough (and may be formed from compacted sand or the like) so that the brine is drawn through the lower evaporator plate via capillary transport. External faces of the lower evaporator plate are adapted for accumulation and evaporation of pure water from the brine.

The pure water vapor is collected and either drawn off or condensed in a central portion of the housing. A first volume of pure water evaporates from the saline solution drawn through the upper evaporator plate (s), the first gas causing the first volume of pure water vapor to drop under the force of gravity toward the centrally positioned condenser. A second volume of pure water evaporates from the brine drawn through the lower evaporator plate(s), the second gas causing the second volume of pure water vapor to rise toward the centrally positioned condenser.

These and other features of the present invention will become readily apparent upon further review of the following specification.

### BRIEF DESCRIPTION OF THE DRAWINGS

FIG. 1 is a diagrammatic view of a fluid density-driven desalination system according to the present invention.

FIG. 2A is a diagrammatic view of thermal valve for controlling heat flow in the fluid density-driven desalination system of FIG. 1.

FIG. 2B is a diagrammatic view of an alternative embodiment of a thermal valve for controlling heat flow in the fluid density-driven desalination system of FIG. 1.

FIG. 3 is a diagrammatic view illustrating capillary transport of brine in an evaporation plate of the fluid density-driven desalination system of FIG. 1.

FIG. 4A is a diagrammatic view of a first wall for a fluid density-driven cooling or heating enclosure according to the present invention.

FIG. 4B is a diagrammatic view of a second wall for a fluid density-driven cooling or heating enclosure according to the present invention.

FIGS. 4C and 4D are diagrammatic views of third and fourth walls, respectively, for a fluid density-driven cooling or heating enclosure according to the present invention.

FIG. 5A is a diagrammatic view of a fluid density-driven cooling enclosure formed from the walls of FIGS. 4A-4D.

FIG. 5B is a diagrammatic view of a fluid density-driven heating enclosure formed from the walls of FIGS. 4A-4D.

Similar reference characters denote corresponding features consistently throughout the attached drawings.

### DETAILED DESCRIPTION OF THE PREFERRED EMBODIMENTS

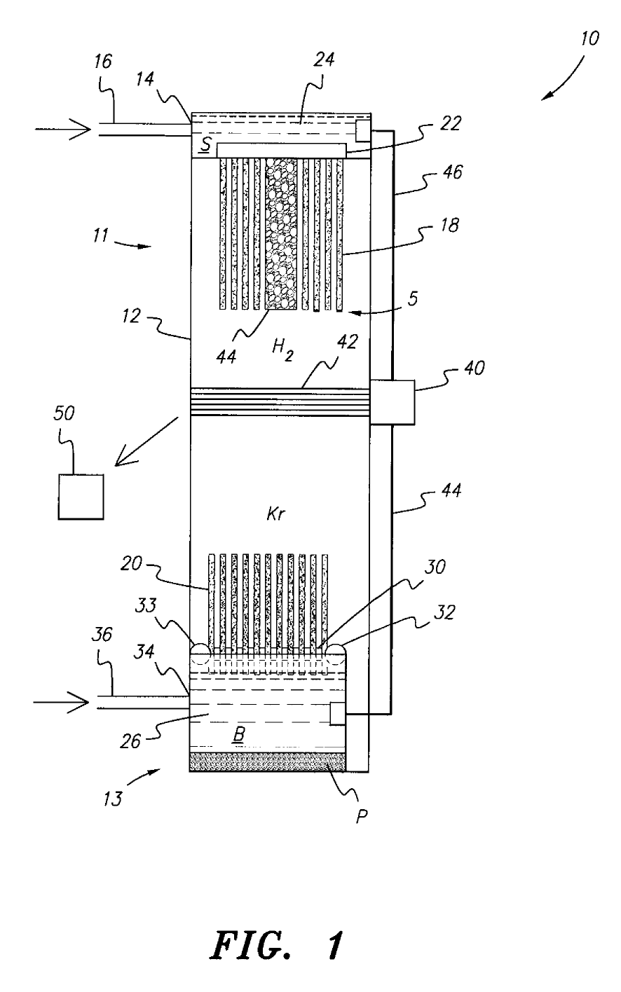

Referring to FIG. 1, the fluid density-driven desalination system 10 is an evaporative desalination system using gases having differing molecular weights to assist in the evaporation and condensation of pure water vapor. The fluid density-driven desalination system 10 includes a housing 12 having an upper portion 11 and a lower portion 13. An upper chamber 24 is formed in the upper portion 11 of the housing 12 for storing a volume of saline solution S.

The lower portion 13 of the housing 12 is adapted for receiving a volume of brine B. The upper portion 11 of the housing 12 external to the upper chamber 24 is adapted for receiving a first gas having a molecular weight less than that of water vapor. In FIG. 1, hydrogen (H₂) is shown as the gas filling the upper portion 11 external to chamber 24, although it should be understood that any suitable gas having a molecular weight less than that of pure water vapor may be utilized. For example, helium may also be utilized. As shown in FIG. 1, the first gas may be introduced and distributed in the upper portion 11 via a bubbling column 44, as is well known in the art. Preferably, the first gas is heated prior to introduction to the upper portion 11 via solar heating or the like, and may be filtered through a micro- or nano-scale mesh or the like to produce bubbles having small diameters. Further, brine collectors 5 may be mounted to the lower ends of plates 18, as shown, to prevent leftover brine from mixing with the fresh condensate formed at the bottom of the structure.

Similarly, the lower portion 13 is adapted for receiving a second gas above a surface of the volume of brine B. The second gas has a molecular weight greater than that of water vapor. In FIG. 1, krypton (Kr) is shown as the gas filling the lower portion 13 above the volume of brine B, although it should be understood that any suitable gas having a molecular weight greater than that of water vapor may be utilized. For example, Ar, Xe, C₆H₁₂ or SF₆ may also be utilized. Preferably, an upper port 14 is formed through the housing 12 so that the saline solution S may be fed directly into the upper chamber 24 by a feed pipe 16. Any suitable type of pump or the like may be used to selectively control feeding the saline solution S into the chamber 24. Similarly, a lower port 34 is preferably formed through the housing 12 so that the brine B may be fed directly into the lower portion 13 by a feed pipe 36. It should be understood that any suitable type of pump or the like may be used to selectively control feeding the brine B into the lower portion 13.

A support 22 is mounted in the upper portion 11 of the housing 12. The support 22 defines the lower wall of the upper chamber 24. At least one upper evaporator plate 18 is mounted to the support 22 and is in fluid communication therewith. The support 22 may be porous, allowing the upper evaporator plate(s) 18 to be in fluid communication with the saline solution S through the porous support 22, or the support 22 may suspend the upper evaporator plate(s) 18 so that an upper edge thereof is in contact with the saline solution S (i.e., projects through the support 22 into the upper chamber 24). The upper evaporator plate(s) 18 extends downward from the support 22, but with the upper evaporator plate(s) 18 being in fluid communication with the upper chamber 24. The upper evaporator plate(s) 18 may be formed from compacted sand or the like, and has a plurality of capillaries defined therethrough so that the saline solution S is drawn through the evaporator plate(s) 18 via capillary transport. External faces of the upper evaporator plate(s) 18 are adapted for accumulation and evaporation of pure water from the saline solution S transported through the capillaries. Alternatively, or in addition, the saline solution S may trickle down the evaporator plate(s) 18 under the force of gravity without reliance on capillary action.

Similarly, at least one lower evaporator plate 20 is supported within the lower portion 13 of the housing 12. A lower end of the lower evaporator plate 20 is in fluid communication with the volume of brine B. The lower evaporator plate(s) 20 also has a plurality of capillaries defined therethrough (and may be formed from compacted sand or the like) so that the brine B is drawn through the lower evaporator plate(s) 20 via capillary transport. External faces of the lower evaporator plate(s) 20 are adapted for accumulation and evaporation of pure water from the brine B.

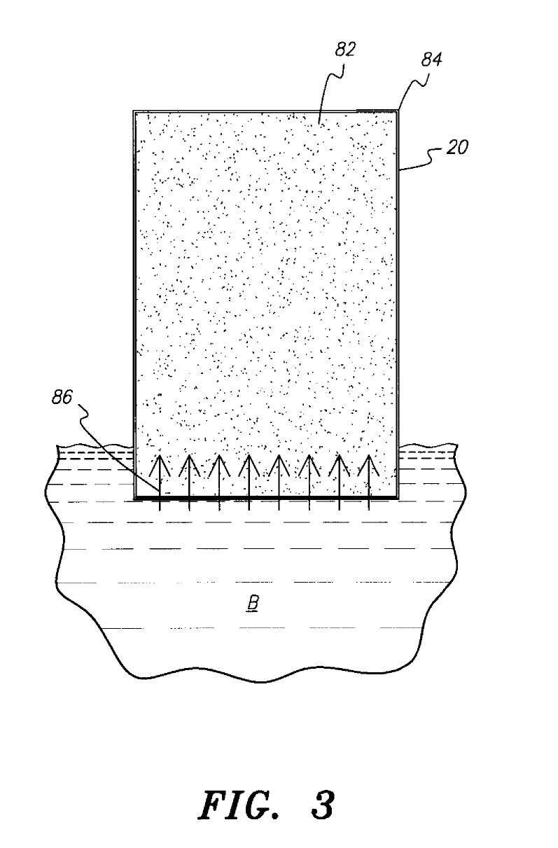

FIG. 3 illustrates a lower evaporator plate 20 having an external frame 84 containing compacted sand 82. Arrows 86 indicate the brine B being transported upward and through the lower evaporator plate 20 by capillary transport through capillaries formed between the grains of compacted sand. The sand 82 may be mixed with a binder and compacted mechanically. Preferably, the lower evaporator plate(s) 20 and the upper evaporator plate(s) 18 are identically formed. Each is preferably formed as a plate having a thickness on the order of a few millimeters. As shown in FIG. 1, the floor of the housing 12 is preferably adapted for collecting salt that precipitates from the brine B during evaporation.

The lower end of the lower evaporator plate(s) 20 may be suspended in the brine B by any suitable type of mounting. Preferably, as shown in FIG. 1, a buoyant (with respect to the brine B) support 30 is positioned to float on the surface of brine B, and the lower end of the lower evaporator plate(s) 20 is secured thereto and in fluid communication with brine B. The support 30 may include external floats 32. Similar to the support 22 described above, the support 30 may be porous, allowing the at least one lower evaporator plate 20 to be in fluid communication with the brine B through the porous support 30, or the support 30 may hold the lower evaporator plate(s) 20 so that a lower edge thereof is in contact with the brine B.

The pure water vapor is collected and either drawn off or condensed in a central portion of the housing 12. As shown in FIG. 1, a plurality of centrally positioned condenser plates 42 are mounted within the housing 12 between the upper portion 11 and the lower portion 13 thereof. Water vapor is driven to the central portion of the housing 12 by the variation in density between the density of the first and second gases and the density of water vapor, and then condensed on plates 42 for collection. The pure water may then be drawn off by any conventional method and stored in a tank 50. Alternatively, the water vapor may be drawn out of the housing 12 in a gaseous state and condensed external to the housing 12.

A first volume of pure water evaporates from the saline solution S drawn through the upper evaporator plate(s) 18. The first gas causes the first volume of pure water vapor to drop under the force of gravity toward the centrally positioned condenser plates 42 (the first gas, being less dense than water vapor, rises towards the top of the upper portion 11, the pure water vapor, being more dense, falling towards the central portion of the housing 12). A second volume of pure water evaporates from the brine B drawn through the evaporator plate(s) 20, the second gas (being more dense than water vapor) causing the second volume of pure water vapor to rise toward the centrally positioned condenser plates 42.

As shown in FIG. 1, a third gas is preferably introduced into the housing 12. The third gas has a molecular weight similar to that of water vapor. Neon (Ne) may be the third gas, although it should be understood that any gas (e.g., methane) having a similar molecular weight may be used. The third gas accumulates about the plurality of condenser plates 42 in the central portion of the housing 12. The pure water vapor is accumulated in the third gas. Condensation is assisted by a passively cooled surface, such as exemplary condenser plates 42 of FIG. 1. It should be understood that any type of condensation surface may be utilized. Additional cooling may by applied by an external refrigeration unit, chiller or the like. Alternatively, ultrasonic or electrostatic means of assisted condensation could also be used in addition to the passive condensation on condenser plates 42. It should be understood that any suitable type of cooler or condenser may be used, such as the generalized condenser unit 40 diagrammatically illustrated in FIG. 1.

The cooling of the condenser plates 42 is primarily effectuated by passive heat exchange between the upper chamber 24 containing saline solution 5, the lower pool of brine B formed in lower portion 13 of housing 12, and the condenser plates 42. Condenser or cooler 40 preferably includes a heat exchanger, with the heat exchanger being in thermal communication with the saline solution S (to provide heat thereto) via a heat pipe or the like 46, and the heat exchanger is further in thermal communication with the brine B via a heat pipe 44 or the like to maintain the brine B at a relatively low temperature. It should be understood that any suitable type of heat pipes, thermally conductive lines or the like may be used to effectuate the thermal exchange. Thermal contact with the saline solution S and the brine B is preferably performed through direct contact (i.e., thermal conduction). A conventional contact is preferably immersed in each, and the conventional contact may be further surrounded by a layer of thermally conducted fluid, such as a thin oil or a thin hydrogen gas layer, to prevent scaling, which typically reduces the thermal conductivity of the interface.

Preferably, the saline solution S is maintained in a heated state. As noted above, the first gas is preferably heated prior to introduction into the upper portion 11. This may be utilized to heat the saline solution S. Additional heating may be caused through the use of solar energy or the like, allowing for radiant heat transfer to directly heat the upper chamber 24. Additionally, as described above, the heat output of the condenser 40 may be used to heat the saline S, and the condenser 40 may include a heat exchanger or the like. Similarly, as described above, the condenser 40 may be cooled by the brine B (shown diagrammatically via heat pipe 44). The saline solution S may be used as a heat sink, allowing for collection of thermal energy during the daytime, for example, to be used as a thermal source in the evenings.

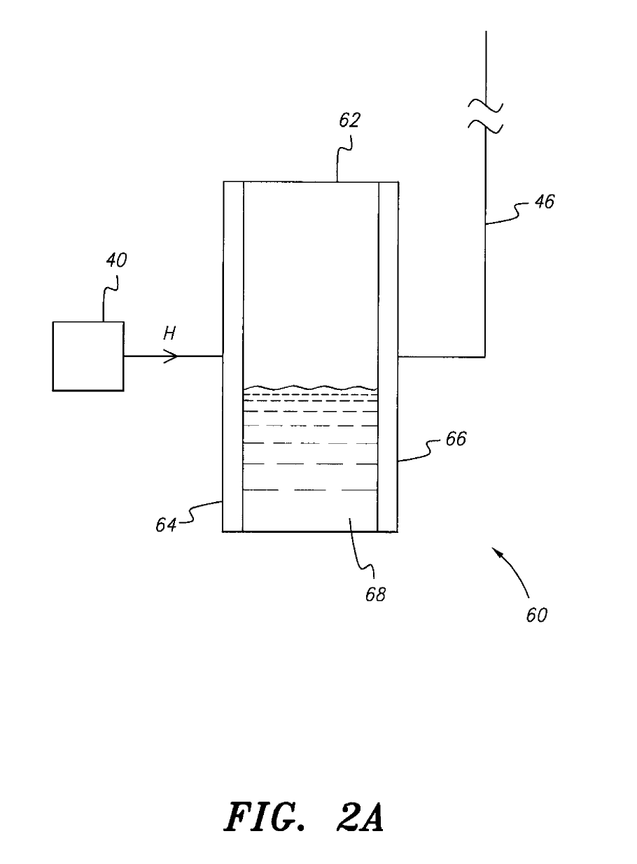

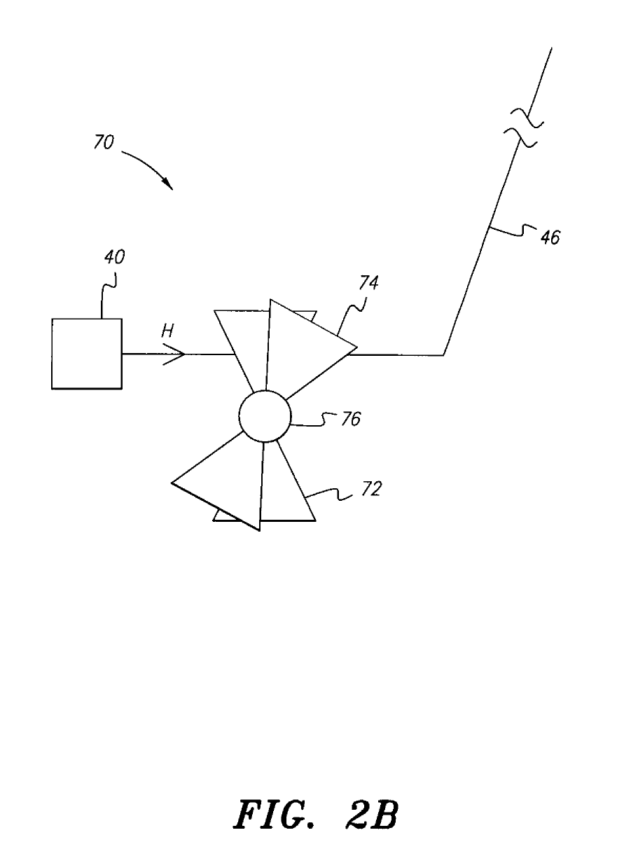

The user may selectively control the heat transfer rate between the condenser 40 and the upper chamber 24 by any suitable type of thermal valve. FIG. 2A illustrates a thermal valve 60 that allows for variable thermal conduction without mass transfer. The thermal valve 60 includes a vessel 62 having first and second thermally conductive sidewalls 64, 66, respectively, and being adapted for receiving a thermally conductive fluid 68. The first thermally conductive sidewall 64 is in thermal communication with the condenser 40 for receiving thermal energy (in the form of heat) H, and the second thermally conductive sidewall is in thermal communication with the upper chamber 24 via pipe 46. The user may vary the volume of the thermally conductive fluid 68 contained within the vessel 62 to selectively control heat transfer between the first and second thermally conductive sidewalls 64, 66, respectively.

FIG. 2B illustrates an alternative heat valve 70, although it should be understood that any suitable controller for controlling heat transfer between the condenser 40 and the saline solution S may be used. The thermal valve 70 includes first and second thermally conductive plates 72, 74, respectively, pivotally joined to one another by pivot 76. The first thermally conductive plate 72 is in thermal communication with the condenser 40 and the second thermally conductive plate 72 is in thermal communication with the upper chamber 24. The user may selectively rotate the first plate 72 with respect to the second plate 74 to selectively vary a surface area of contact therebetween to control the heat transfer rate therebetween.

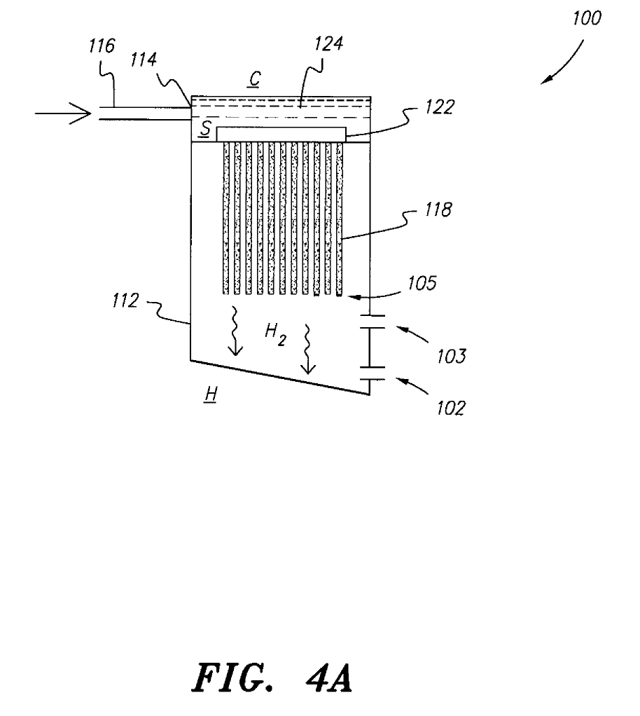

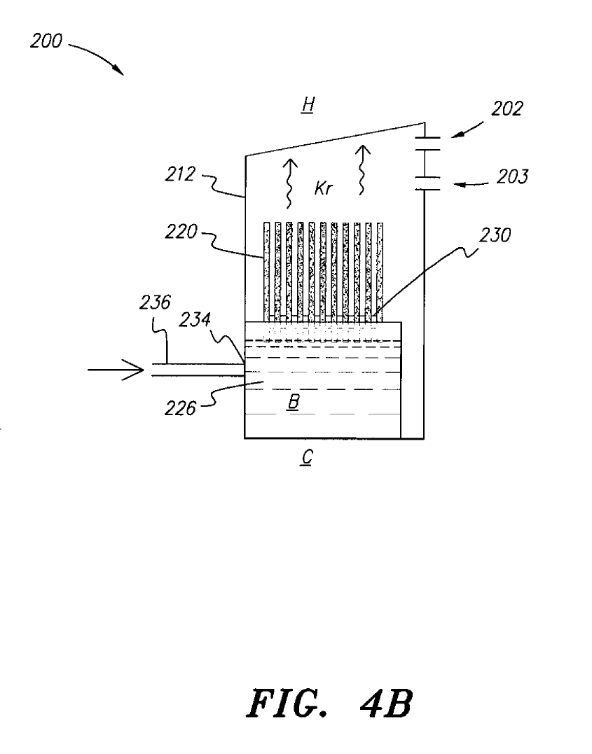

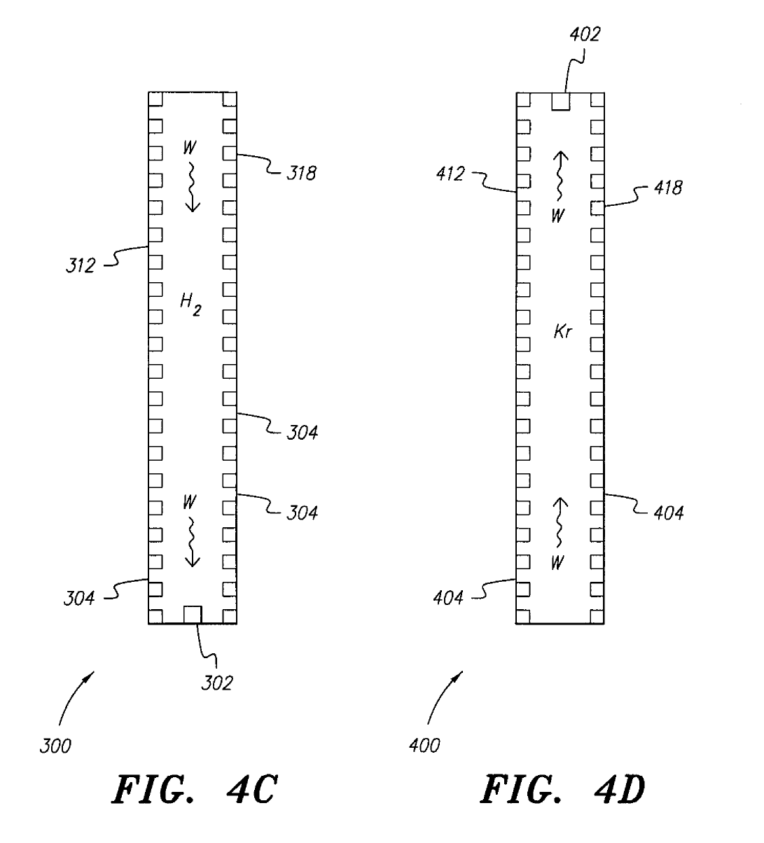

FIG. 4A illustrates a first wall 100 for a fluid density-driven cooling or heating enclosure that operates similar to the upper portion of system 10 of FIG. 1. The first wall 100 is hollow, having a rigid external housing 112 defining an upper chamber 124 in the upper portion of the housing 112 for storing a volume of saline solution S. The upper portion of the housing 112 external to the upper chamber 124 is adapted for receiving a first gas having a molecular weight less than that of water vapor. In FIG. 4A, hydrogen (H₂) is shown as the gas filling the housing 112 external to chamber 124, although it should be understood that any suitable gas having a molecular weight less than that of pure water vapor may be utilized. For example, helium may also be utilized.

As further shown in FIG. 4A, the first gas may be introduced and distributed in the upper portion external to the upper chamber 124, as is well known in the art. As opposed to the above-described embodiment, there is no bubble column, nor is the envelope pre-heated.

Preferably, an upper port 114 is formed through the housing 112 so that the saline solution S may be fed directly into the upper chamber 124 by a feed pipe 116. Any suitable type of pump or the like may be used to selectively control feeding the saline solution S into the chamber 124. A support 122 is mounted in the upper portion 11 of the housing 12. The support 122 defines the lower wall of the upper chamber 124. At least one upper evaporator plate 118 is mounted to the support 122 and is in fluid communication therewith.

The support 122 may be porous, allowing the upper evaporator plate(s) 118 to be in fluid communication with the saline solution S through the porous support 122, or the support 122 may suspend the upper evaporator plate(s) 118 so that an upper edge thereof is in contact with the saline solution S (i.e., projects through the support 122 into the upper chamber 124). The upper evaporator plate(s) 118 extends downward from the support 122, but with the upper evaporator plate(s) 18 being in fluid communication with the upper chamber 124. The upper evaporator plate(s) 118 may be formed from compacted sand or the like, and has a plurality of capillaries defined therethrough so that the saline solution S is drawn through the evaporator plate(s) 118 via capillary transport. External faces of the upper evaporator plate(s) 118 are adapted for accumulation and evaporation of pure water from the saline solution S transported through the capillaries. Alternatively, or in addition, the saline solution S may trickle down the evaporator plate(s) 118 under the force of gravity, without reliance on capillary action.

Similar to that described above with reference to FIG. 1, the evaporated water vapor will flow downward under the force of gravity. In the first wall 100, water vapor may be released through a lower port 102, as shown in FIG. 4A. A second port 103 may also be provided for extracting vapor in addition to the liquid extraction. Due to evaporative cooling, the upper portion of housing 112 will provide a cooled surface (indicated as C in FIG. 4A), thus allowing the first wall 100 to be used whenever it is desired to drive heat downward and leave a cooler side above the wall 100. Further, brine collectors 105 may be mounted to the lower ends of plates 118, as shown, to prevent leftover brine from mixing with the fresh condensate formed at the bottom of the structure.

Similarly, FIG. 4B illustrates a second wall 200 for a fluid density-driven cooling or heating enclosure that operates similar to the lower portion of system 10 of FIG. 1. The second wall 200 includes a rigid external housing 212 defining a lower chamber 226 formed in the lower portion of the housing 212 for storing a volume of brine B. The lower portion of the housing 212 external to the lower chamber 226 is adapted for receiving a second gas having a molecular weight greater than that of water vapor. In FIG. 4B, krypton (Kr) is shown as the gas filling the lower portion above the volume of brine B, although it should be understood that any suitable gas having a molecular weight greater than that of water vapor may be utilized. For example, Ar, Xe, C₆H₁₂ or SF₆ may also be utilized.

Preferably, a lower port 234 is formed through the housing 212 so that the brine B may be fed directly into the lower chamber 226 by a feed pipe 236. Any suitable type of pump or the like may be used to selectively control feeding the brine B into the chamber 226. At least one lower evaporator plate 220 is supported within the lower portion of the housing 212. A lower end of the lower evaporator plate 220 is in fluid communication with the volume of brine B. The lower evaporator plate(s) 220 also has a plurality of capillaries defined therethrough (and may be formed from compacted sand or the like) so that the brine B is drawn through the lower evaporator plate(s) 220 via capillary transport. External faces of the lower evaporator plate(s) 220 are adapted for accumulation and evaporation of pure water from the brine B.

The lower end of the lower evaporator plate(s) 220 may be suspended in the brine B by any suitable type of mounting. Preferably, as shown in FIG. 4B (similar to system 10 of FIG. 1), a buoyant (with respect to the brine B) support 230 is positioned to float on the surface of brine B, and the lower end of the lower evaporator plate(s) 220 is secured thereto and in fluid communication with brine B. Similar to the supports 22 and 122 described above, the support 230 may be porous, allowing the at least one lower evaporator plate 220 to be in fluid communication with the brine B through the porous support 230, or the support 230 may hold the lower evaporator plate(s) 220 so that a lower edge thereof is in contact with the brine B.

As described above with reference to FIG. 1, the evaporated water vapor will flow upward due to the heavier (with respect to molecular weight) second gas. In the second wall 200, the water vapor may be released through an upper port 202, as shown in FIG. 48. Additionally, a second port 203 may be added for liquid extraction in addition to the vapor extraction. Due to evaporative cooling, heat will be driven upward in the water vapor and the lower side of the wall 200 will provide a cooled surface (indicated as C in FIG. 4B).

FIGS. 4C and 4D illustrate a third wall 300 and a fourth wall 400, respectively, for a fluid density-driven cooling or heating enclosure. In FIG. 4C, the third wall 300 includes a rigid external housing 312 having a pair of sidewalls 304 defining a hollow interior for carrying a supply of saline solution S or brine B. A plurality of evaporation plates 318 (similar to the evaporation plates described above with respect to system 10 of FIG. 1) are mounted within the housing 312, in fluid communication with the sidewalk 304. The housing 312 is filled with H₂ or a similar gas that has a molecular weight less than that of water vapor. In a manner similar to that described above, the evaporated water vapor will flow downward under the force of gravity (indicated by arrows W), and may be released through a lower port 302, thereby releasing heat absorbed by the water vapor. The exterior surfaces of hollow sidewalls 304 will be cooled by evaporative cooling.

Similarly, in FIG. 4D, the fourth wall 400 includes a rigid external housing having a pair of hollow sidewalls 404 defining a hollow interior for carrying a supply of saline solution S or brine B. A plurality of evaporation plates 418 (similar to the evaporation plates described above with respect to system 10 of FIG. 1) are mounted within the housing 412, in fluid communication with the sidewalls 404. The housing 412 is filled with Kr or a similar gas that has a molecular weight greater than that of water vapor. In a manner similar to that described above, the evaporated water vapor will flow upward (indicated by arrows W) due to the difference in molecular weights, and may be released through an upper port 402, thereby releasing heat absorbed by the water vapor. The exterior surfaces of the sidewalls 404 will be cooled by evaporative cooling.

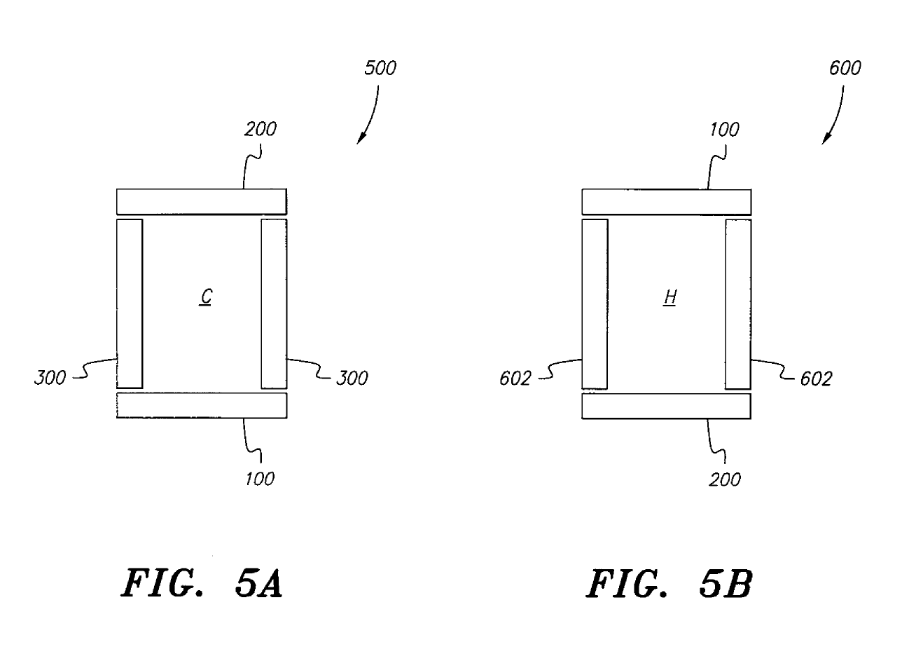

FIG. 5A diagrammatically illustrates a fluid density-driven cooling enclosure 500 or “cold envelope” utilizing walls 100, 200 and 300. The first wall 100 forms the floor of the cooling enclosure 500 and the second wall forms the roof or ceiling of the cooling enclosure 500. The cold upper surface of the first wall 100 is positioned at the lower end of the cooling enclosure 500 facing the interior of the enclosure 500, and the cold lower surface of the second wall 200 is positioned at the upper end of the cooling enclosure 500 facing the interior of the enclosure 500. A pair of third walls 300 may be used to form sidewalls of the cooling enclosure 500, thus creating a cooled interior surface (indicated as C in FIG. 5A). Similarly, FIG. 5B diagrammatically illustrates a fluid density-driven heating enclosure 600 or “hot envelope” utilizing walls 100 and 200. The first wall 100 forms the roof or ceiling of the heating enclosure 600, and the second wall 200 forms the floor of the heating enclosure 600. The order of walls 100 and 200 is reversed as compared to the cooling enclosure 500, thus positioning the cold lower surface of unit 200 and the cold upper surface of unit 100 facing the exterior of the heating enclosure 600, leaving the remaining relatively warm surfaces facing inwardly, thus heating the interior of heating enclosure 600 (indicated as H in FIG. 5B). Thermally insulating or separately heated walls 602 may be used to seal the interior of the heating enclosure 600.

In usage, the cooling enclosure 500 may be used in the construction of a building or the like, with the second wall 200 being roof-mounted and the first wall 100 being floor-mounted, with the walls of the building being constructed with third walls 300. During the daytime, the net water vapor flow is downward. This may be collected in an underground storage tank or the like, where the water vapor is condensed and may be added to the supply of saline solution. The underground storage tank will serve not only to collect the saline, but also provide for storage of thermal energy transferred by the water vapor. In the evenings, the heat may be utilized for warmth, or to continue cooling operations, with the net vapor movement now being in the upward direction. This may be coupled with the fourth wall, and connected to a separate condenser or radiator.

It is to be understood that the present invention is not limited to the embodiments described above, but encompasses any and all embodiments within the scope of the following claims.

1. A fluid density-driven desalination system, comprising:
a housing having an upper portion and a lower portion, and an upper chamber formed in the upper portion of the housing for storing saline solution, the lower portion of the housing being adapted for receiving and containing a volume of brine;
a first gas having a molecular weight less than that of water vapor, the first gas being disposed in the upper portion external to the upper chamber;
a second gas having a molecular weight greater than that of water vapor, the second gas being disposed in the lower portion of the housing;
a support mounted in the upper portion of the housing, the support defining a lower wall of the upper chamber;
at least one upper evaporator plate mounted to the support, the at least one upper evaporator plate being in fluid communication with the upper chamber, the at least one evaporator plate extending downward from the support, the at least one upper evaporator plate having a plurality of capillaries defined therethrough adapted for drawing the saline from the upper chamber therethrough via capillary transport, the at least one upper evaporator plate having external faces adapted for accumulation and evaporation of the saline therefrom, the at least one upper evaporator plate having at least one brine collector mounted on a lower end thereof;
at least one lower evaporator plate supported within the lower portion of the housing, the at least one lower evaporator plate having a lower end positioned for being in fluid communication with the volume of brine, the at least one lower evaporator plate having a plurality of capillaries defined therethrough so that the brine is drawn therethrough via capillary transport, the at least one lower evaporator plate having external faces adapted for accumulation and evaporation of brine therefrom, the at least one lower evaporator plate having an upper end, the upper end of the at least one lower evaporator plate being maintained in a wet state by brine dripping thereon; and
means for collecting condensed water vapor, the means for collecting being positioned substantially centrally in the housing;
whereby, a first volume of pure water evaporates from the saline solution drawn through the at least one upper evaporator plate, the first gas causing the first volume of pure water vapor to drop under the force of gravity toward the means for collecting condensed water vapor, and a second volume of pure water evaporates from the brine drawn through the at least one lower evaporator plate, the second gas causing the second volume of pure water vapor to rise toward the means for collecting condensed water vapor.

2. The fluid density-driven desalination system as recited in claim 1, further comprising a bubbling column mounted in the upper portion of said housing for distributing the first gas therein.

3. The fluid density-driven desalination system as recited in claim 1, wherein a lower wall of said housing is adapted for collecting a salt precipitate from evaporation of the volume of brine.

4. The fluid density-driven desalination system as recited in claim 1, further comprising a lower support, said at least one lower evaporator plate being mounted to the lower support.

5. The fluid density-driven desalination system as recited in claim 4, wherein the lower support is porous and buoyant with respect to the volume of brine, and is adapted for floating thereon.

6. The fluid density-driven desalination system as recited in claim 5, wherein the lower porous support includes at least one buoyant float.

7. The fluid density-driven desalination system as recited in claim 1, wherein both said at least one upper and at least one lower evaporator plates are formed from compacted sand.

8. The fluid density-driven desalination system as recited in claim 1, further comprising:
a condenser mounted outside said housing; and
a plurality of condenser plates extending substantially centrally within said housing, the condenser plates communicating with the condenser.

9. The fluid density-driven desalination system as recited in claim 8, further comprising means for transferring heat output from the condenser to the upper chamber to heat the saline solution.

10. The fluid density-driven desalination system as recited in claim 9, further comprising means for selectively controlling the heat transfer rate between the condenser and the upper chamber.

11. The fluid density-driven desalination system as recited in claim 10, wherein said means for selectively controlling the heat transfer rate between the condenser and the upper chamber comprises a vessel having first and second thermally conductive sidewalls, the vessel being adapted for receiving a thermally conductive fluid, wherein the first thermally conductive sidewall is in thermal communication with the condenser and the second thermally conductive sidewall is in thermal communication with the upper chamber, whereby the user may vary the volume of the thermally conductive fluid contained within the vessel to selectively control heat transfer between the first and second thermally conductive sidewalls.

12. The fluid density-driven desalination system as recited in claim 10, wherein said means for selectively controlling the heat transfer rate between the condenser and the upper chamber comprises first and second thermally conductive plates pivotally joined to one another, the first thermally conductive plate being in thermal communication with the condenser, the second thermally conductive plate being in thermal communication with the upper chamber, whereby the user may selectively rotate the first plate with respect to the second plate to selectively vary a surface area of contact therebetween to control the heat transfer rate therebetween.

13. The fluid density-driven desalination system as recited in claim 9, further comprising means for cooling the volume of brine.

14. The fluid density-driven desalination system as recited in claim 13, further comprising a third gas having a molecular weight approximately equal to that of water vapor, the third gas being disposed within the housing about the plurality of condenser plates.

15. A fluid density-driven desalination system, comprising:
a housing having an upper portion and a lower portion, an upper chamber being formed in the upper portion of the housing for storing saline solution, the upper portion external to the upper chamber being adapted for receiving a gas having a molecular weight less than that of water vapor;
a support mounted in the upper portion of the housing, the support defining a lower wall of the upper chamber;
at least one upper evaporator plate mounted to the support and extending downward therefrom, the at least one upper evaporator plate being in fluid communication with the upper chamber and having a plurality of capillaries defined therethrough so that the saline solution is drawn therethrough via capillary transport, external faces of the at least one upper evaporator plate being adapted for accumulation and evaporation thereof; and
means for collecting condensed water vapor, the means being positioned in the lower portion of the housing, whereby a volume of pure water evaporates from the saline solution drawn through the at least one upper evaporator plate, the gas causing the volume of pure water vapor to drop under the force of gravity toward the means for collecting condensed water vapor.

16. The fluid density-driven desalination system as recited in claim 15, further comprising a bubbling column mounted in the upper portion of said housing for distributing the gas therein.

17. The fluid density-driven desalination system as recited in claim 15, wherein the at least one upper evaporator plate is formed from compacted sand.

18. A fluid density-driven desalination system, comprising:
a housing having an upper portion and a lower portion, the lower portion thereof being adapted for receiving and containing a volume of brine, the upper portion being adapted for receiving a gas above a surface of the volume of brine, the gas having a molecular weight greater than that of water vapor;
at least one lower evaporator plate supported within the lower portion of said housing so that a lower end thereof is in fluid communication with the volume of brine, the at least one lower evaporator plate having a plurality of capillaries defined therethrough so that the brine is drawn therethrough via capillary transport, external faces of the at least one lower evaporator plate being adapted for accumulation and evaporation thereof; and
means for collecting condensed water vapor positioned in the upper portion of the housing, whereby a volume of pure water evaporates from the brine drawn through the at least one lower evaporator plate, the gas causing the volume of pure water vapor to rise toward the means for collecting condensed water vapor.

19. The fluid density-driven desalination system as recited in claim 18, wherein the at least one lower evaporator plate is formed from compacted sand.

20. The fluid density-driven desalination system as recited in claim 18, further comprising:
a condenser mounted to said housing; and
a plurality of condenser plates positioned in the upper portion of said housing.

21-26. (canceled)
